(19) United States
(12) Patent Application Publication
(10) Pub. No.: US 2004/0082346 A1
(43) Pub. Date: Apr. 29, 2004

(54) Enhanced-service provision

(75) Inventors: Magnus Skytt, Sollentuna (SE); Gregg Fenton, Northport, NY (US)

Correspondence Address: ERICSSON INC., 6300 LEGACY DRIVE, M/S EVR C11, PLANO, TX, 75024, US

(73) Assignee: Telefonaktiebolaget LM Ericsson (publ), Stockholm (SE)

(21) Appl. No.: 10/448,080

(22) Filed: May 29, 2003

(30) Foreign Application Priority Data
Oct. 29, 2002 (SE) 0203188-8

(51) Int. Cl. H04Q 7/20

(52) U.S. Cl. 455/456.3; 455/414.2

(57) ABSTRACT

Automatic provision or registration of an enhanced-service that has not yet been provisioned for that service is detected and processed within a mobile system. Upon introduction into a mobile communication system, the mobile unit is detected as enhanced-service capable and non-provisioned. A configuration message including information is transmitted to the mobile unit. This information enables the mobile unit to manage the enhanced service. In addition, a detection signal, including a service agreement identifier associated with the mobile unit is transmitted to an enhanced-service center comprising an enhanced-service database or register. The center registers the mobile unit as enhanced-service capable by updating the database based on the received service agreement identifier.

This application claims the benefit of the filing date as provided by 35 U.S.C. 119 of Swedish patent application number 0203188-8 filed on Oct. 29, 2002, the disclosure of which is incorporated herein by reference.

### BACKGROUND OF THE INVENTION

During the last decades, the use of mobile telephones and other mobile units in mobile communication systems has increased tremendously. Furthermore, in the last few years, also the number of available services for mobile units in such systems have increased, for example by adopting or implementing services traditionally associated PCs (Personal Computers) and the Internet, such as IM (Instant Messaging), IMPS (Instant Messaging and Presence Service) and streaming services. Also several new services, adapted for mobile communication systems, have emerged or will be provided, including for example MMS (Multimedia Messaging Service) and location-based services. However, when a new mobile unit is introduced into the mobile communication system, the mobile unit as such typically first have to be configured and the subscriber directories of an operator, to which a user of the mobile unit has a subscription, has to be updated before the user actually may employ these services.

In order to configure the mobile unit, some data or software is typically downloaded and installed or activated in the mobile unit. In addition, the operator's subscriber directories are updated, identifying the mobile unit as capable of supporting and managing the service(s).

Today, the main solution for updating the operator's subscriber directories is that the user contacts the customer care of the network operator, after purchase of a new service capable mobile station. Alternatively, the user may visit a web page provided by the network operator and fill in a registration form, typically including identifying the mobile telephone number and model of his/her new mobile unit. This form is then transmitted to the network operator, allowing the customer care to register the mobile unit as service capable.

Naturally, this is not an advantageous solution, requiring manual intervention by the user. Furthermore, it may take a considerable time after the purchase before the user contacts the customer care or finds the registration form on the Internet. During this time, although the mobile unit actually may have been configured for the services, the user of the mobile unit is not able to employ them until the operator has updated his register with the mobile unit as service capable.

Another possible solution for the operator could be bulk provisioning or registration. In such a case, the operator registers all mobile units of the users of his operator domain as service capable. Thus, making no distinguish between mobile units that are service capable and those (legacy) mobile units that do no support the services. This is a far from optimal solution, since the operator then may provide services, e.g. send MMS messages, to a mobile unit that actually does not support the services, e.g. is not able to receive and manage MMS messages.

For MMS services, a presently used solution for operator provisioning or registration, employed by e.g. Vodafone, is that the user sends a MMS message, for example to the network operator (Vodafone). By sending the MMS message, the communication system identifies the mobile unit as MMS capable and contacts the network operator, allowing him to register or provision the mobile unit. Thus, in this MO (Mobile Oriented) solution the user himself/herself has to initiate the MMS transmission. Furthermore, it is expected that most users will receive several MMS messages before sending any. The problem is that the user, however, can not receive any MMS messages before the operator has been updated with information that the mobile unit is MMS capable. Thus, the user might miss several MMS messages before transmitting his/her first MMS message.

### BRIEF SUMMARY OF THE INVENTION

Neither of the prior art solutions discussed in the background section, requiring some form of user intervention, for enabling use of a supplementary or enhanced service in a mobile unit is satisfactory, neither from user point of view nor the viewpoint of network operators. This problem or requiring user intervention for enabling usage of an enhanced service is solved by the invention.

It is a general object of the present invention to enable usage of an enhanced service for enhanced-service capable user equipment in a mobile communication system.

It is another object of the invention to provide provision or registration of such enhanced-service capable user equipment introduced into the mobile communication system.

Yet another object of the invention is to provide an automatic registration of enhanced-service capable user equipment that has not yet been provisioned for support of the enhanced service.

A further object of the invention is to provide such user equipment provisioning or registration requiring no user intervention.

These and other objects are met by the invention as defined by the accompanying patent claims.

Briefly, the present invention involves automatic provision or registration of enhanced-service capable user equipment, which has not yet been provisioned for support of the enhanced service, when introduced in a mobile communication system. Thus, when a user purchases a new user equipment, e.g. mobile telephone or other mobile unit, capable of supporting an enhanced service, e.g. MMS messaging, that user equipment first has to be configured for the enhanced service before being able to use the service. In addition, the communication system has to provision the user equipment, typically, by updating an operator's directory or register, identifying the user equipment as capable of and configured for the enhanced service. The present invention provides method and systems that automatically updates the communication system.

Thus, when a non-provisioned enhanced-service capable user equipment is introduced into the system, a configuration center detects the user equipment as enhanced-service capable and verifies that it is not yet provisioned for enabling support of that service. The configuration center also preferably identifies a model of the user equipment, e.g. based on information associated with the user equipment, such as IMEI (International Mobile station Equipment Identity) or TAC (Type of Approval Code) for mobile units. The configuration center preferably identifies the user equipment as new or non-provisioned by comparing the combination of service agreement information and model information, e.g. IMSI (International Mobile Subscriber Identity) and IMEI, of the user equipment with information stored in an associated configuration database or register of already enhanced-service configured and provisioned user equipment. If the present combination is not found in the database and the user equipment is able to support the enhanced-service, the configuration center generates a detection signal or message including the service agreement information or identifier associated with the user equipment. Such information or identifier could be an identifier of a network subscriber identity module, such as IMSI, MSISDN (Mobile Station International ISDN Number; ISDN (Integrated Services Digital Network)) or mobile telephone number. The identity module is typically a SIM (Subscriber Identity Module) card used in GSM (Global System for Mobile communications) mobile units, an UMTS (Universal Mobile Telecommunications System) SIM (USIM), a WIM (Wireless Identity Module) or an ISIM (IP multimedia Services Identity Module) card. In addition, the detection signal includes a notice identifying the user equipment associated with the service agreement information as service capable and preferably also the determined model information of the user equipment.

The generated detection signal is then transmitted either directly to an enhanced-service center, where the user equipment is registered, or to the enhanced-service center through a provisioning center. In the latter case, the provisioning center identifies the service agreement information in the detection signal and retrieves additional service-agreement-related information and payment method information from an associated user database or register. Thus, this user database includes information of the user's service agreement with a network operator or other service provider, and is used to identify the correct allowances and settings for the particular user equipment. For example, the information in the user database can state that a certain user is not allowed to use SMS (Short Message Service) messaging. In addition, the database preferably includes information of the payment method, e.g. postpaid, prepaid, of the enhanced service, thereby allowing correct billing for the enhanced service from the beginning. The provisioning center then forwards the received detection signal complemented with the retrieved additional information to the enhanced-service center.

Upon reception of the detection signal, whether from the configuration center or from the provisioning center, the enhanced-service center updates an associated enhanced-service database or register based on the received information. This database includes information of user equipment that has been provisioned for the enhanced service, payment method of the enhanced service and additional information associated with the service, user equipment and/or user. Based on the service agreement information in the detection signal the enhanced-service center registers the user equipment as enhanced-service capable, and enters the model information, payment method and further information, if provided, in the database.

Once the user equipment is to employ an enhanced service, the mobile communication system looks up the enhanced-service database to, on one hand, verify that the user equipment is enhanced-service capable, and on the other, identify how the service should be billed and additional information required for a seamless application of the service.

The configuration center is also adapted for generating and transmitting a configuration message to the user equipment upon generation of the detection signal. This message includes information, which, when provided to the user equipment, configures the equipment for support and management of the enhanced service. Typically the information in the configuration message includes addresses or information allowing the user equipment to contact an enhanced-service provider, e.g. URI (Universal Resource Identifier)/URL (Uniform Resource Locator), WAP GW (Wireless Application Protocol Gateway) and APN (Access Point Name) addresses of the enhanced-service provider. The configuration message is preferably selected or generated based on the model of the user equipment, as determined based on the identified model information.

In addition to provisioning or registering enhanced-service capable user equipment, the enhanced-service center could also be configured for providing a link or means for using an example of the enhanced service. Correspondingly to above, this link could be selected or generated based on model information received in the detection signal. The enhanced-service center then includes the link in a notification message transmitted to the user equipment. If the information of the configuration message has been successfully installed in the user equipment, that equipment is now able to transmit an enhanced-service request message to the enhanced-service center based on the link or means in the notification message. This request message comprises, in addition to the actual enhanced-service request, also the service agreement information and optionally the model information of the user equipment. Upon reception of the request message, the enhanced-service center knows that the user equipment has successfully been configured for the service and generates an acknowledge message including the service agreement information provided in the request message. This acknowledge message is transmitted to the configuration center. In response to reception of the acknowledge message, the configuration center registers the user equipment as configured by updating its associated configuration database based on the received service agreement information.

The enhanced services of the invention are supplementary services that may be provided by or from a service provider, e.g. a network operator, to the user equipment. Enhanced services include, but are not limited to, services traditionally associated with computers, PCs (Personal Computers) and the Internet. Also services specially adapted for mobile communication systems are included in the expression. These enhanced services are typically associated with a subscription or other service agreement with the service provider or network operator. The services may be free or chargeable, e.g. prepaid or postpaid services, and/or services debited in connection with payment of the user's subscription to the operator. Typical, non-limiting, examples of enhanced services according to the invention are multimedia services, MMS (Multimedia Messaging Service), IM (Instant Messaging), IMPS (Instant Messaging and Presence Service), multimedia conferencing services, chat services and presence services. Furthermore, data providing services, e.g. streaming and content download services, may be enhanced services according to the invention. Further examples include location-based services, push services, push-to-talk services, video telephony and video conferencing services, SIP (Session Initiation Protocol) services and enhanced voice services.

The invention offers the following advantages:

No user intervention is required for registering or provisioning non-provisioned or new enhanced-service capable user equipment;

Users will be able to employ new enhanced services directly or shortly after switching on the user equipment for the first time;

Allows network operators to welcome new users having a service agreement with, e.g. subscription to, the operators;

Network operators are able to automatically set a defined class of services and allowances for a new user; and

Allows acknowledge of successful configuration of user equipment for enabling management of enhanced service.

Other advantages offered by the present invention will be appreciated upon reading of the below description of the embodiments of the invention.

### BRIEF DESCRIPTION OF THE DRAWINGS

The invention together with further objects and advantages thereof, may best be understood by making reference to the following description taken together with the accompanying drawings, in which:

FIG. 1 is a schematic overview of a mobile communication system employing the present invention;

FIG. 2 is illustration of an embodiment of a mobile communication system including a provisioning system according to the present invention;

FIG. 3 is illustration of another embodiment of a mobile communication system including a provisioning system according to the present invention;

FIG. 4 is illustration of a further embodiment of a mobile communication system including a provisioning system according to the present invention;

FIG. 5 is illustration of yet another embodiment of a mobile communication system including a provisioning system according to the present invention;

FIG. 6 is a schematic block diagram of an embodiment of a configuration center according to the present invention;

FIG. 7 is a schematic block diagram of an embodiment of a provisioning center according to the present invention;

FIG. 8 is a schematic block diagram of an embodiment of an enhanced-service center according to the present invention;

FIG. 9 is a schematic block diagram of an embodiment of a mobile unit applicable in a mobile communication system according to the present invention;

FIG. 10 is a flow diagram of the general steps of the enhanced-service enabling method of the present invention; and

FIGS. 11A-C are a flow diagrams of additional steps of the enhanced-service enabling method of the present invention.

### DETAILED DESCRIPTION OF THE INVENTION

Throughout the drawings, the same reference characters will be used for corresponding or similar elements.

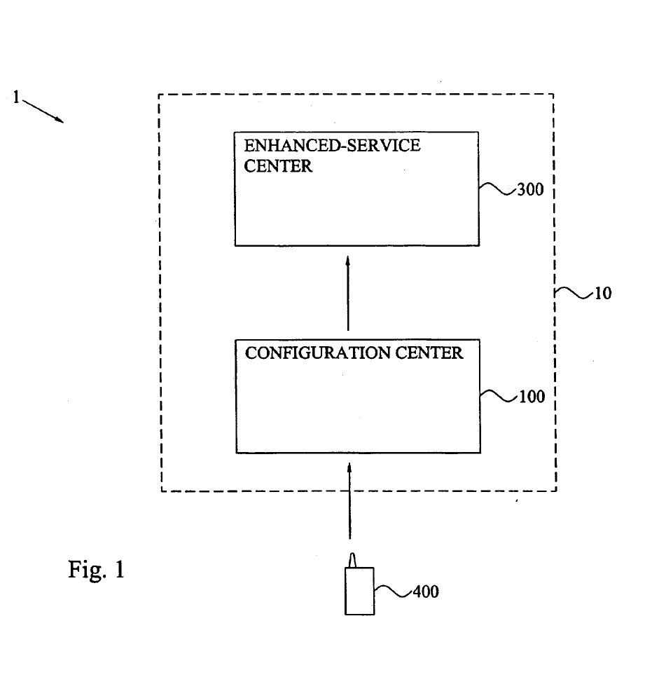

In order to gain a basic and intuitive understanding of the invention, a brief description of a mobile communication system employing the invention follows with reference to FIG. 1.

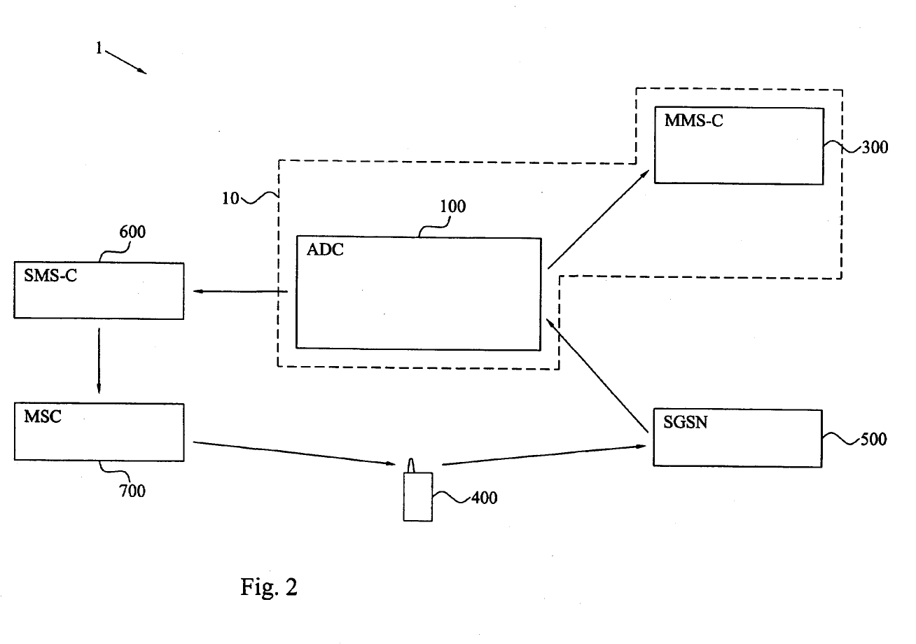

The mobile communication system 1 is adapted for automatic enhanced-service or supplementary-service provisioning or registration of service capable user equipment 400, e.g. mobile unit, introduced into the system 1. In FIG. 1 and the following FIGS. 2-5 only units and elements of the mobile communication system 1 pertinent to the discussion of the present invention are illustrated in the figures.

The mobile communication system 1 of the present invention comprises a provisioning system 10, which is generally provided for automatic detection and registration of non-provisioned enhanced-service capable mobile units 400 in the mobile communication system 1. The provisioning system 10 automatically updates an operator's directory or register of service capable mobile units, thereby enabling usage of the enhanced services for a provisioned, i.e. configured and registered, mobile unit.

The expression non-provisioned enhanced-service capable mobile unit refers, in the present description, to a mobile unit that has the possibility of using an enhanced service but presently is actually not able to employ the service. This is due to that the mobile unit first has to be configured for the enhanced service and/or the communication system has to be updated, i.e. register the mobile unit as enhanced-service capable. Thus, a non-provisioned mobile unit could be a newly purchased unit that is switched on for the first time within a communication network provided by a network operator. Alternatively, the mobile unit is not newly purchased but new in the sense that it could be capable of using an enhanced or supplementary service but has not yet been configured or registered for use thereof. In this case, the user might, through a subscription or other service agreement with the network operator or a service provider, have got access to the enhanced service and is now to get his/her mobile unit provisioned for enabling usage of the service. In the above mentioned cases, in order to successfully enable usage of the service, typically, the mobile unit has to be configured for the service and the communication system (operator's directory) has to register the user as having access to an enhanced-service capable mobile unit.

In another possible scenario according to the invention, a non-provisioned mobile unit could actually already be configured for an enhanced service. However, the operator's directory has not yet been updated, identifying a user as presently having access to an enhanced-service capable mobile unit. This could be the case, when a user arranges his/her associated subscriber identity module (SIM) in an already enhanced-service configured mobile unit. However, for the user to actually employ the enhanced service, the directory of the operator issuing the SIM first has to register the associated user as having access to a (configured) enhanced-service capable mobile unit. Similarly, a mobile unit might already be enhanced-service configured at purchase thereof, so only a registration in the operator's directory is necessary.

Returning to FIG. 1, the provisioning system 10 typically includes a configuration center 100 and an enhanced-service center 300. The configuration center 100 detects and verifies that the mobile unit 400 as enhanced-service capable but not yet provisioned for the service. Based on the detection, the configuration center 100 generates a detection signal or message comprising information of a service agreement between the user of the mobile unit 400 and the operator. Such a service agreement could be a subscription associated with the user, which is discussed in more detail below. The generated detection signal is then transmitted to the enhanced-service center 300. Upon reception of the detection signal, the enhanced-service center 300 updates an enhanced-service database or register based on the service agreement information. This database comprises information of users having a service agreement with network operators. The enhanced-service center 300 registers the mobile unit 400 as enhanced-service capable in the database, thereby allowing the mobile unit 400 to employ the enhanced service, provided that the mobile unit 400 also has been configured for that service. The enhanced-service center 300 could be a specific server or center provided in the mobile communication system 1, such as in the provisioning system 10. Alternatively, the center 300 could be a part of an operator's generic provisioning system.

The expression “enhanced service” refers, in the present description, to a supplementary service that may be provided by or from a service provider, e.g. a network operator, to a user's mobile unit. Enhanced services include, but are not limited to, services traditionally associated with computers, PCs (Personal Computers) and the Internet. Also services adapted for mobile communication systems are included in the expression. These enhanced services are typically associated with a subscription or other service agreement with the service provider or network operator. The services may be free or chargeable, e.g. prepaid or postpaid services, and/or services debited in connection with payment of the user's subscription to the operator. Typical, non-limiting, examples of enhanced services according to the invention are multimedia services, MMS (Multimedia Messaging Service), IM (Instant Messaging), IMPS (Instant Messaging and Presence Service), multimedia conferencing services, chat services and presence services. Furthermore, data providing services, e.g. streaming and content download services, may be enhanced services according to the invention. Further examples include location-based services, push services, push-to-talk services, video telephony and video conferencing services, SIP (Session Initiation Protocol) services and enhanced voice services.

In the following, the present invention will be described in more detail with reference to a particular example of enhanced service, namely MMS service. However, as the skilled in the art understands, the invention is not limited to this particular example, but may comprise any other enhanced service, such as one of the services identified above.

FIG. 2 is an illustration of an embodiment of a mobile communication system 1 according to the present invention. When a mobile unit 400 is switched on within the system 1, it typically performs a GPRS (General Packet Radio Service) attach to a SGSN (Serving GPRS Service Node) 500. The SGSN node 500 then determines, e.g. based on the attach mode or operation of the mobile unit 400, if the mobile unit 400 is a candidate unit that potentially is MMS capable but not yet provisioned for MMS messaging. In connection with the attach procedure, the SGSN node 500 receives a message comprising at least an identifier of the mobile unit 400, such as an identifier of a service agreement of the user of the mobile unit 400 with an operator. The message indicates that the identified mobile unit 400 is to be provisioned for MMS service. Such a message is typically sent, for example, by a HLR (Home Location Register) or from operation and maintenance nodes. For more information on detection of MMS capable mobile units reference is made to the patent application PCT/EP02/12677, which is hereby incorporated by reference.

Alternatively, instead of detecting a candidate (non-provisioned MMS capable) mobile unit 400 at GPRS attach, other detection methods may be used. For example, means could be provided in the communication system 1 for listening to the traffic between the mobile unit 400 and a MSC (Mobile Switching Center) 700, i.e. listening to the A-interface between the mobile unit 400 and the MSC 700. The listening and detecting means could then be implemented in the MSC 700, similar to a corresponding detection unit in the SGSN 500, discussed above, or elsewhere implemented.

Upon detection, the SGSN node 500 transmits a message to an ADC (Automatic Device Configuration) center or server 100. The message includes information that the mobile unit 400 potentially should be updated for enabling MMS messaging. Such a message comprises the service agreement information of the mobile unit 400, e.g. subscription information associated the user of the mobile unit 400. The service agreement information may be associated with an identity module, e.g. SIM, arranged in the mobile unit 400 and adapted for cooperation therewith.

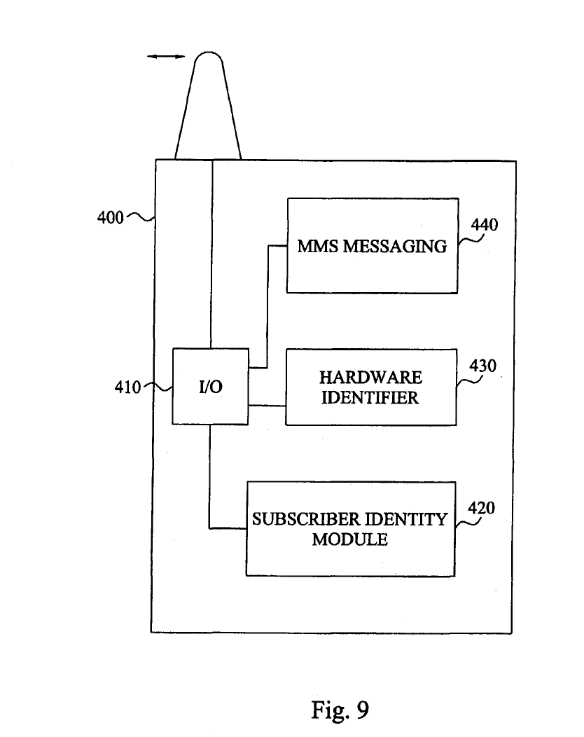

Briefly referring to FIG. 9, the mobile unit 400 is typically adapted for cooperation with a (network) subscriber identity module 420 comprising information identifying the user of the mobile unit 400 (strictly speaking, the owner of the identity module 420). Such an identity module 420 could be a SIM (Subscriber Identity Module) card used in GSM (Global System for Mobile communications) mobile units but also an UMTS (Universal Mobile Telecommunications System) SIM (USIM), a WIM (Wireless Identity Module) or an ISIM (IP multimedia Services Identity Module) card. Also a corresponding identity module built-in the mobile unit, i.e. not detachable therefrom, could comprise or be associated with service agreement information according to the invention. This service agreement information could be an IMSI (International Mobile Subscriber Identity), MSISDN (Mobile Station International ISDN Number; ISDN (Integrated Services Digital Network)) or mobile telephone number, or any other identifier associated with the user or the user's subscription with the operator.

The message transmitted to the ADC center preferably also comprises information associated with an identifier of the mobile unit 400. Such information preferably allows identification of the model or type of the mobile unit 400, which is typically provided as a hardware identifier or number 430 of the mobile unite 400. A typical example of such information is IMEI (International Mobile station Equipment Identity). As the person skilled in the art knows an IMEI number is as X1X2X3X4X5X6Y1Y2Z1Z2Z3Z4Z5Z6Q, where X1-6 is TAC (Type of Approval Code), Y1-2 is FAC (Final Assembly Code) identifying the manufacturer of the mobile unit 400, e.g. Ericsson, Sony-Ericsson, etc., Z1-6 is the serial number and Q is an extra figure, often 0 (X1-6, Y1-2, Z1-6 and Q are any figure from 0 to 9). As an alternative to using the whole IMEI number as a source of model information of a mobile unit 400, the TAC portion of the IMEI can be used.

Returning to FIG. 2, when the ADC 100 receives the message with the service agreement information or identifier, e.g. IMSI, and preferably also the mobile unit identifier, e.g. IMEI, it investigates whether the mobile unit is provisioned or not. The ADC 100 preferably performs this investigation by comparing the received combination of service agreement identifier (IMSI) and mobile unit identifier (IMEI) with identifiers stored in a configuration database or register associated with the ADC center 100. The configuration database comprises service agreement identifier of users and model information of the users' mobile units. If the combination is found in the database, the mobile unit has been MMS provisioned, and therefore already is registered. However, if the combination is not found in the database, the mobile unit 400 is non-provisioned and the mobile communication network has to be updated identifying the user as having access to a MMS capable mobile unit.

When the combination is not found in the database there are a number of different possible scenarios. Firstly, as was mentioned above, a user has bought a new MMS capable mobile unit and has switched it on for the first time. Alternatively, the mobile unit as such is not newly purchased but the user has recently come to an agreement with a MMS service provider or subscribed to the MMS service and is now to configure his/her mobile unit for enabling usage of the MMS service. In a further scenario, the user has switched his/her identity module to another mobile unit than his/her regular or usual one. In such a case, this mobile unit could actually already be configured for MMS messaging. The present invention is then still applicable by registering the user as now having access to a MMS capable mobile unit.

It is anticipated by the present invention that other methods of determining whether a mobile unit is non-provisioned than by comparing the combination of service agreement identifier and mobile unit identifier could be employed for non-provision detection purposes.

The ADC then preferably determines a model or type of the mobile unit 400 based on the mobile unit identifier, such as based on IMEI or based on the TAC code of the IMEI, obtained in the message from the SGSN 500. In addition, the ADC 100 determines if the mobile unit 400 is MMS capable based on the mobile unit identifier or the determined model of the mobile unit 400. Thus, the ADC has, or has access to, a list or register of models of mobile units that are MMS capable. Alternatively, that information may be determined elsewhere and then provided to the ADC 100.

Once it is determined that the mobile unit 400 is MMS capable and not yet registered, the ADC 100, optionally could verify if the mobile unit 400 is configured for MMS messaging by looking up a database of configured mobile units, which is discussed in more detail below. If it is determined, that the mobile unit 400 is not MMS configured, or if no verification is performed, the ADC 100 generates and transmits a configuration message to the mobile unit 400. The configuration message could be a SMS (Short Message Service) message or an OTA (Over The air Activation) message transmitted from the ADC to the mobile unit 400 via an SMS-C (Short Message Service Center) 600 and the MSC 700. As is known in the art, OTA is a special type of SMS that includes the configuration information in a special port of the UDH (User Data Header) of the SMS. The ADC 100 may generate the configuration message based on information of the model of the mobile unit 400, especially for OTA messages, where configuration semantics and capabilities are not generic for all mobile units 400. If the mobile unit 400 already is configured for MMS messaging, as discussed above, the configuration message could still be transmitted, thus reconfiguring the mobile unit 400. Alternatively, no new configuration message is transmitted to the already configured mobile unit.

The configuration message includes information, which, when provided or implemented in the mobile unit 400, enables usage of MMS messaging. The information typically specifies the address to a location where the mobile unit 400 can request or fetch MMS messages. Such addresses could specify the URI (Universal Resource Identifier)/URL (Uniform Resource Locator) of the MMS-C 300, its associated WAP GW (Wireless Application Protocol Gateway) and an APN (Access Point Name) where the MMS-C 300 relies or resides. This information (address) is provided to MMS software (440 in FIG. 9) updating the software and configuring the mobile unit 400 for allowing transmission and reception of MMS messages.

In addition, if the MMS software is not implemented in the mobile unit 400 it could be provided thereto in connection to or in the configuration message. The MMS software could be downloaded for implementation in the identity module of the mobile unit 400. The identity module—mobile unit interface typically is associated with commands intended to send more or less arbitrary data to the identity module for use therein, e.g. the “ENVELOPE” command for GSM SIM cards. The code for implementing MMS software e.g. as a general Java Applet application, could be sent using such commands. In such a case, the MMS software may be implemented in an application environment provided by an application toolkit associated with the identity module, e.g. SAT (SIM Application Toolkit) or UMTS SAT (USAT). Also, the downloaded software may be a portion of a program code, with the remaining portion already provided and implemented in the mobile unit 400. Alternatively, or in addition, the configuration message could include an activation code, which is required to activate software already implemented in the mobile unit 400. Also a combination of software, activation code and/or address information may be transmitted to the mobile unit as a configuration message.

Once received, the information is automatically implemented in and updates the mobile unit 400. Alternatively, manual confirmation is required, for example the user is required to accept the updating, before the information is implemented.

The ADC 100 also generates a detection message or signal in response to detection of a non-provisioned MMS capable mobile unit 400. The detection message comprises the service agreement identifier received from the SGSN node 500, a notification that the mobile unit 400 is MMS capable and preferably also identifier of the model or type of the mobile unit 400. This detection message is then transmitted to an MMS-C (Multimedia Messaging Service Center) 300. The detection message could be in the form of a predetermined template that comprises values of parameters associated with the MMS service, the mobile unit and/or the user's subscription with a network operator. One of these parameters includes the service agreement identifier of the user. Furthermore, a MMS messaging parameter of the template is identified as MMS capable (or not MMS capable, if the mobile unit does not support MMS messaging). Also the model of the mobile unit 400 is entered under the relevant parameter. Some of the parameters of the template may have different default values, if no relevant and more specific information is available.

The MMS-C 300 comprises, or has access to, an MMS-service database or register of service-agreement identifiers, such as IMSI, of one or several network operators. Upon reception of the detection message from the ADC 100, the MMS-C 300 updates the database based on the information included in the message. The MMS-C 300 preferably identifies relevant data of a user in the database based on the service-agreement identifier. The identified data includes information of the model of the user's mobile unit 400, information of MMS delivery method, etc. The model field in the MMS-service database is updated according to the model identifier provided in the detection message. The delivery method field, is updated accordingly, i.e. MMS capable if the mobile unit 400 is supporting MMS messaging, otherwise some default value. A typical default value or indication is that the mobile unit 400 is a legacy mobile unit, i.e. a mobile unit not capable of managing or supporting MMS. Another delivery method is then required for MMS messages destined to the mobile unit. Such an alternative delivery method could be transmitting a SMS to the mobile unit, where the SMS includes at least a portion of the original MMS, e.g. a portion of the payload of the MMS. Another possible legacy delivery method is transmitting a notice to the mobile unit as a SMS. The notice then comprises an address to a web page, which the user has to visit in order to see the content of the original MMS. If no information of the user is found in the database, the MMS-C 300 enters the information of the user and his/her mobile unit provided in the detection signal from the ADC 100.

The MMS-C 300 checks this database when a mobile unit 400 is to transmit or receive a MMS message in order to identify delivery method, i.e. if the mobile unit 400 is MMS capable or if some other delivery method should be employed. Thus, by updating the database and thereby registering the mobile unit 400 as MMS capable, the MMS-C enables the mobile unit to receive and transmit MMS messages.

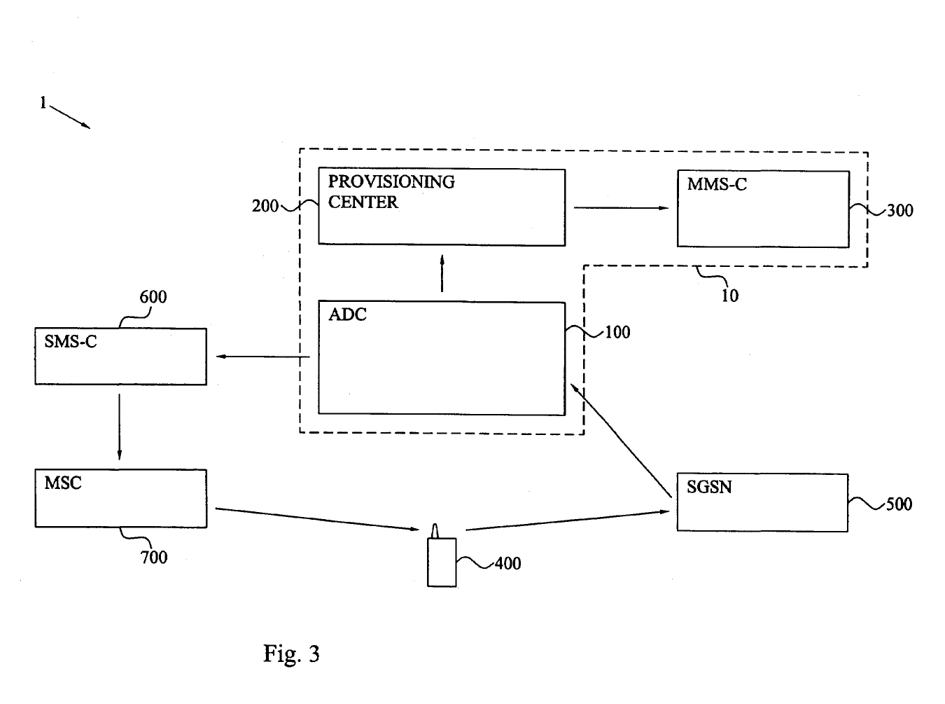

FIG. 3 is an illustration of another embodiment of a mobile communication system 1 according to the invention. This embodiment comprises a somewhat different provisioning system 10 compared to the corresponding embodiment of FIG. 2.

Similar to FIG. 2, the SGSN 500 detects a potential non-provisioned or non-registered mobile unit 400 and notifies the ADC 100 accordingly. The ADC 100 verifies that the mobile unit 400 is MMS capable and not already configured for support of MMS messaging. In addition, the ADC 100 determines the model of the mobile unit 400 and generates the detection message. Contrary to FIG. 2, this detection message is transmitted to a provisioning center 200 provided in the provisioning system 10. This provisioning center 200 comprises, or has access to a database of user information, such as information associated with a subscription of a user with a network operator or service provider. The user information typically includes payment method of the enhanced or supplementary service, i.e. MMS service in the present example. Such payment method could state that the MMS service is a prepaid or postpaid service, and/or that payment of the MMS service should be debited according to a subscription agreement. In addition, the user information may include information of other services, associated with the user's service agreement (subscription) with a service provider, e.g. the network operator. This information defines which additional services the user has access to, such as allowed/not allowed to transmit and/or receive SMS messages, etc., and payment method for these additional services. Thus, the information includes specific abilities and allowances that tailors the user into a predefined class of services for individual operator market plans.

The provisioning center 200 identifies the payment method and any additional service-agreement-related information associated with the user, preferably based on the service agreement identifier included in the detection signal from the ADC 100. This identified information is forwarded by the provisioning center 200 together with the detection message to the MMS-C 300. If the detection message is in the form of a template with parameters, as discussed above, the provision center 200 enters the payment information and any information of the MMS service and/or other services in the template, which is forwarded to the MMS-C 300.

The MMS-C 300 updates its associated MMS-service database based on the information received from the provisioning center 200. Thus, similar to FIG. 2, the mobile unit 400 is registered in the database as MMS capable, i.e. MMS is selected as delivery method instead of legacy or default. Also the model of the mobile unit is updated and registered in the database. In addition, the database is updated based on information of the payment method from the provisioning center 200. This allows correct payment setting for the subscribers in the network from the beginning. In addition, any additional service-agreement-related information, such as access and allowances of additional services and their corresponding payment settings, may be entered in the database.

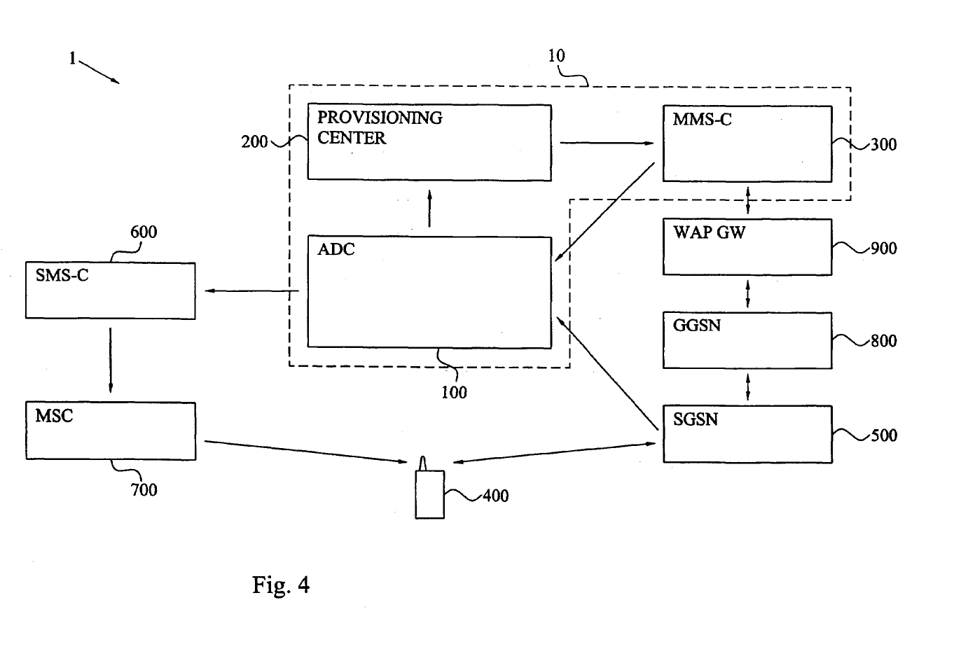

FIG. 4 is an illustration of a further embodiment of a mobile communication system 1 including a provisioning system 10 according to the present invention. The operation of the provisioning system 10 is similar to FIG. 3. However, once the MMS-C 300 receives a detection message from the provisioning center 200, it, in addition to updating its associated MMS-service database, generates a link to different MMS. This MMS link preferably is a predefined link to different MMS, e.g. stored in connection to the MMS-C 300. The MMS-C 300 could determine which MMS from the storage to provide as a link based on the model or type of the mobile unit 400 and possibly service related information, if such information was included in the received detection signal. If no information of the model was included, or if the MMS-C otherwise has no predetermined link associated with such a model, default MMS could be provided.

The MMS-C 300 then generates a MMS notification message that includes the MMS link. Similar to generating or providing the MMS link, the MMS-C 300 preferably generates the notification message based on the model of the mobile unit 400, or uses a default notification message. The associated storage of the MMS-C 300 can also comprise predefined notification messages that are adapted for one or several models of mobile units. The message could also comprise some welcome or introduction text defined by the network operator, to which the user of the mobile unit 400 has a subscription, or some information associated with the model of the mobile unit 400. The MMS-C 300 could follow the simple C-like flow scheme:

```
enum MS_Types {MS_brand_1, MS_brand_2, ...};
enum MS_Types MMS_MS;
switch (MMS_MS)
{
    case MS_brand_1:
        MMS_notification=MS_brand_1_MMS_notification ( );
        break;
    case MS_brand_2:
        MMS_notification=MS_brand_2_MMS_notification ( );
        break;
    ...
    default:
        MMS_notification=MS_default_MMS_notification ( );
        break;
}
SendSMS(MMS_notification, MSISDN);
```

The MMS-C 300 then transmits the MMS notification including the MMS link to the mobile unit 400. The MMS-C 300 could transmit the notification message as a SMS trough the SMS-C 600 and the MSC 700.

Alternatively, the MMS-C 300 generates or provides the MMS link and forwards it to the ADC 100. The ADC 100 then provides the notification message, includes the link therein and transmits it to the mobile unit 400.

The mobile unit 400 receives the notification (SMS) message with the MMS link. Since the mobile unit 400 is MMS capable and already has received the configuration message from the ADC 100, and therefore supports MMS messaging, it may request the MMS provided by the link in the notification message. This MMS may either be automatically downloaded to the mobile unit 400 upon reception of the notification message or user interaction may be required to download the MMS, depending on the settings of the mobile unit 400.

Typically, the mobile unit 400 activates GPRS session with the PDP (Packet Data Protocol) context activation to the APN where the MMS-C 300 relies or resides, resulting in a logical link establishment between the SGSN 500 access point and the mobile unit 400. Service agreement identifier (IMSI/MSISDN) of the mobile unit 400 is forwarded from a GGSN (GPRS Gateway Support Node) 800 to a WAP GW 900. Subsequently, a WSP (WAP Session Protocol) session is established from the mobile unit 400 towards the WAP GW 900. A WSP get command with reference to the requested MMS in the MMS notification is forwarded to the MMS-C 300. The WAP GW 900 adds the service agreement identifier in the request to the MMS-C 300, or the MMS-C 300 gets the service agreement identifier by other means, e.g. manually transmitted from the user or automatically pulled from an AAA (Authentication Authorization Accounting) server.

The requested MMS is downloaded over the WAP GW 900, GGSN 800 and the SGSN 500 to the mobile unit 400. Upon reception of the requested MMS, the MMS application of the mobile unit 400 activates and pops up, telling the user that a new MMS has arrived. The user then can see the MMS, typically after pressing or selecting “view” or similar. This received MMS allows the user to get an idea of what MMS is and what could be done with MMS, thus giving him/her some experience of managing MMS before sending or receiving additional MMS messages. Furthermore, receiving the requested MMS message decreases any entry barrier of start using MMS messaging experienced by the user and thus allowing the usage of the MMS service to increase unimpededly and smoothly.

The downloaded MMS may also include information from the operator, e.g. a greeting message, thus allowing the operator to get an opportunity to welcome the user.

When the MMS-C 300 receives the request for the MMS including the service agreement identifier from the mobile unit 400, it knows that the mobile unit 400 associated with the service agreement identifier actually has been successfully configured for MMS messaging. In other words, the MMS-C 300 knows that the configuration message from the ADC 100 has been transmitted to the mobile unit 400 and the MMS-enabling information in the message has been implemented in the mobile unit 400, i.e. the user has accepted the updating. The MMS-C 300 then generates an acknowledge message or signal including the service agreement identifier of the requesting mobile unit 400 that has successfully been implemented for enabling MMS. This message is then transmitted to the ADC 100, which updates its associated configuration database or register with information of service agreements and models of mobile units. Thus, the ADC 100 registers the mobile unit 400, based on the service agreement identifier in the acknowledge message, as configuration verified in the database.

Alternatively, when the user of the mobile unit accepts implementation of the MMS-enabling information in his/her mobile unit, an acknowledge message is transmitted from the unit to the ADC. Similar to above, this acknowledge message comprises the service agreement identifier of the user and a notification that the associated mobile unit has been successfully configured for MMS messaging. The ADC then registers or updates the mobile unit as MMS configured in the configuration database.

In this embodiment, the ADC may be configured for retransmitting the configuration message to the mobile unit if the acknowledge message from the MMS-C or mobile unit is not received within a predetermined time period. Thus, anew allowing the MMS enabling information to be reimplemented in the mobile unit, if there was some error in the original implementation. Alternatively, allowing or reminding the user to accept the updating, if forgotten to press or select accept.

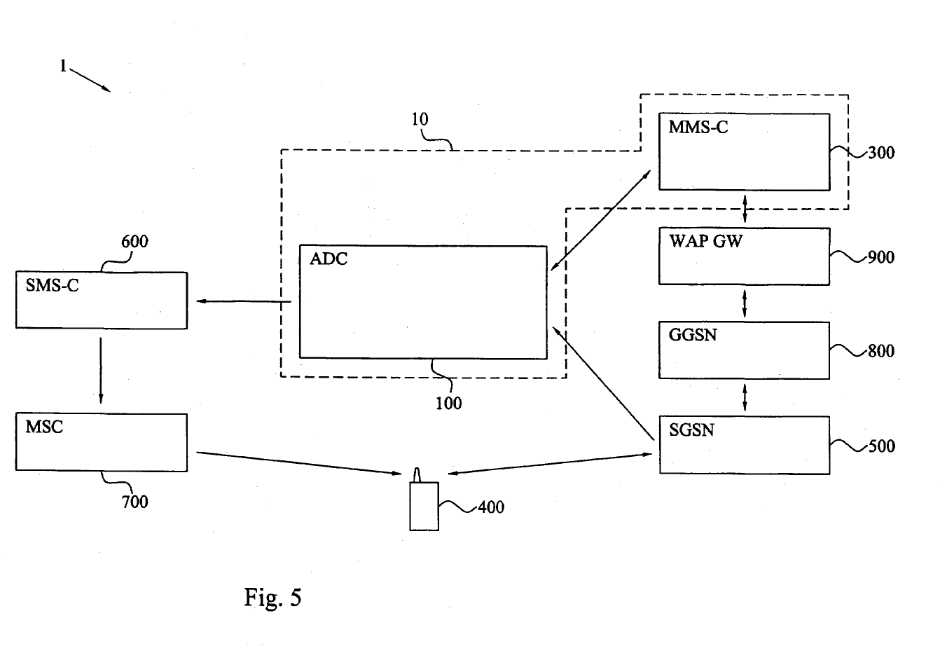

FIG. 5 is yet another embodiment of a mobile communication system 1 according to the present invention. This embodiment is similar to FIG. 4, except that the provisioning center of FIG. 4 is missing in the provisioning system 10 of FIG. 5. Thus, in this embodiment no extra service-agreement-related information, including payment information, is entered based on the detection message in the MMS-service database associated with the MMS-C 300. This embodiment could be used when all, or most of the, subscribers of a network operator already have predetermined, preferably all have the same, payment method, e.g. postpaid or prepaid, thereby requiring no updating or registration of such information.

In an alternative embodiment of the invention, the MMS-C updates its associated MMS-service database and registers the mobile unit as MMS capable in response to the MMS request originating from the mobile unit. Returning anew to FIGS. 4 and 5, once the ADC 100 has determined that the mobile unit 400 is MMS capable but has not yet been configured for MMS management or been registered as MMS capable, it generates a detection signal or message, which was discussed in more detail in the foregoing. In addition, the configuration message is transmitted, e.g. as an OTA message, to the mobile unit 400 to configure it for enabling MMS messaging. The generated detection message is either transmitted directly to the MMS-C 300 (FIG. 5) or through the provisioning center 200 (FIG. 4). Upon reception, the MMS-C 300 provides the MMS link and includes it in the notification message transmitted to the mobile unit 400. If the mobile unit 400 successfully has implemented/received the MMS enabling (address) information, it can request the MMS, provided as a link in the notification message, from the MMS-C 300. Once the request, including the service agreement identifier (IMSI/MSISDN) associated with the mobile unit 400 and preferably its associated IMEI, or another identifier of the model of the unit 400, is received by the MMS-C 300, a check up in the MMS-service database based on the service agreement identifier is performed. If the information not already exists in the database, the MMS-C 300 enters the information, updates the mobile unit 400 as MMS capable and notices the model of the unit 400, if information thereof is provided in the request. If the service agreement identifier already exists in the MMS-service database, the user may have switched his/her identity module to a new mobile unit 400. Then the MMS-C 300 updates the model of the unit 400 and possibly its capabilities and any additional service-agreement-related information. Thus, in this embodiment a reuse of the MO (Mobile Oriented) autoprovision mechanism could be employed when fetching or requesting the MMS.

Alternatively, a bulk provisioning or registration mechanism could be employed for adding all or some of the users, e.g. subscribers, associated with a network operator in the MMS-service database of the MMS-C. The database will thus be populated with all or some subscribers within the operator's network. Also payment method and any other generic service-agreement-related information may be entered in the database. In such a case, the delivery method for the MMS field should be set to legacy, i.e. non-MMS capable. When a non-configured MMS capable mobile unit is detected by the ADC, a detection message, including the service agreement identifier, notification of that the unit is MMS capable and preferably identifier of the model of the unit, is transmitted to the MMS-C. Upon reception, the MMS-C updates the MMS-service database with the optionally provided model identifier and sets the MMS delivery method as MMS capable. In addition, if the mobile unit does not support MMS, the model field preferably still is updated based on the received model information and the MMS-C verifies that the MMS delivery field is legacy. This could be important in order to provide the best possible service for the user, since the user could, at least temporary, have moved his/her identity module, e.g. SIM or USIM, from his/her regular or usual MMS capable mobile unit into a non-MMS capable mobile unit. Thus, the user is now not able to receive any MMS messages. However, if the database of the MMS-C is updated accordingly, the MMS-C knows that the user now is using a non-MMS capable mobile unit and therefore provides any MMS messages destined to the user by means of another delivery mechanism, e.g. SMS messaging or displays the MMS message(s) on a web page.

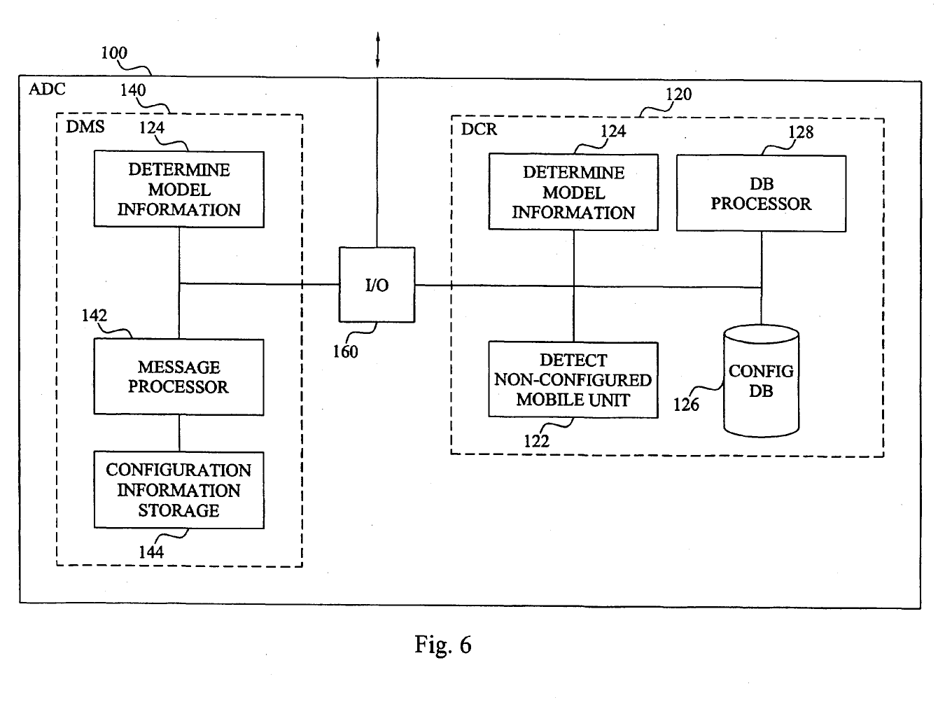

FIG. 6 is a block diagram of an embodiment of a configuration center illustrated as an ADC 100. The ADC 100 generally comprises or may be interpreted as comprising a DCR (Device Configuration Register) 120 and a DMS (Device Management Server) 140.

The DCR 120 comprises means 122 adapted for detecting and verifying non-provisioned MMS capable mobile units, typically based on input information provided from a SGSN node during GPRS attach or dedicated A-interface listening means, which was discussed above in connection to FIG. 2. This detecting means 122 is further configured for generating the detection signal or message, including the service agreement identifier, e.g. MSISDN or IMSI, of the user of the mobile unit and preferably also identifier of the model of the mobile unit, e.g. IMEI or TAC code. The model or type identifier is determined by means 124 provided in the DCR 120. The determining means 124 is adapted for determining the model based on some information associated with the unit, e.g. the IMEI of the mobile unit, or the TAC code portion of the IMEI. The DCR 120 further comprises or has access to a configuration database 126 that includes information about which mobile units that has received a MMS configuration message and which mobile units that actually has been configured for MMS messaging, as determined based on reception of the acknowledge message from the MMS-C or mobile unit. This database 126 typically identifies MMS configured mobile units by their IMEI or another terminal or hardware identifier. A database processor 128 is implemented in the DCR 120 for updating the database 126 based on transmission of configuration messages and reception of acknowledge messages.

The DMS portion 140 of the ADC 100 comprises a message processor 142 for generating the configuration message transmitted to the mobile unit. The processor 142 is preferably adapted for generating the message based on the model of the mobile unit as determined by the determining means 124 of the DCR 120. For example, the message processor 142 may have access to a number of predefined standard messages and then selects a suitable configuration message from the standard messages based on the model information, where each standard message is adapted for one or several particular models of mobile units. Storage 144 is provided in, or associated with, the ADC 100. This storage 144 includes the configuration information included and transmitted in the configuration message to mobile units. In addition, the storage 144 could include standard notification messages, from which the message processor 142 selects a configuration message, preferably bases on model information. Optionally, the DMS 140 may be provided with means for determining the model of mobile unit, similar to the determining means 124 of the DCR 120.

An input/output (I/O) unit 160 is implemented in the ADC 100. This I/O unit 160 manages on one hand internal communication within the ADC 100, i.e. between the DCR 120 and the DMS 140, and on the other hand external communication between the ADC 100 and external network or mobile units. As a person skilled in the art understands, the I/O unit 160 can be provided for only managing external communication, whereas any internal communication between the units and means of the DCR 120 and DMS 140 is conducted on a dedicated bus arranged in the ADC 100. However, the I/O unit 160 preferably transmits the detection signal or message to the MMS-C or provisioning center, transmits and retransmits configuration messages, and receives acknowledge messages or signals from the MMS-C.

The division of the ADC 100 into a DCR 120 and a DMS 140 portion should at first hand be viewed as a natural division of the two main operations of the ADC 100, namely detecting and confirming non-provisioned MMS capable mobile units and determining and model information performed by the DCR 120, and generating notification and configuration messages performed by the DMS 140. Thus, as a person skilled in the art understands, also an ADC 100 without a division into a DCR 120 and a DMS 140, but still comprising the functional units 122-128, 142-144 of the DCR 120 and DMS 140, identified and described above, is within the scope of the invention.

The units 122, 124, 128, 142 and 160 of the ADC 100 may be provided as software, hardware or a combination thereof. They may be implemented together for example in a network node of a mobile communication system. Alternatively, a distributed implementation is also possible with some of the units provided in different network nodes, e.g. the units and database 122-128 of the DCR 120 in one node and the units 142-144 of the DMS 140 in another node.

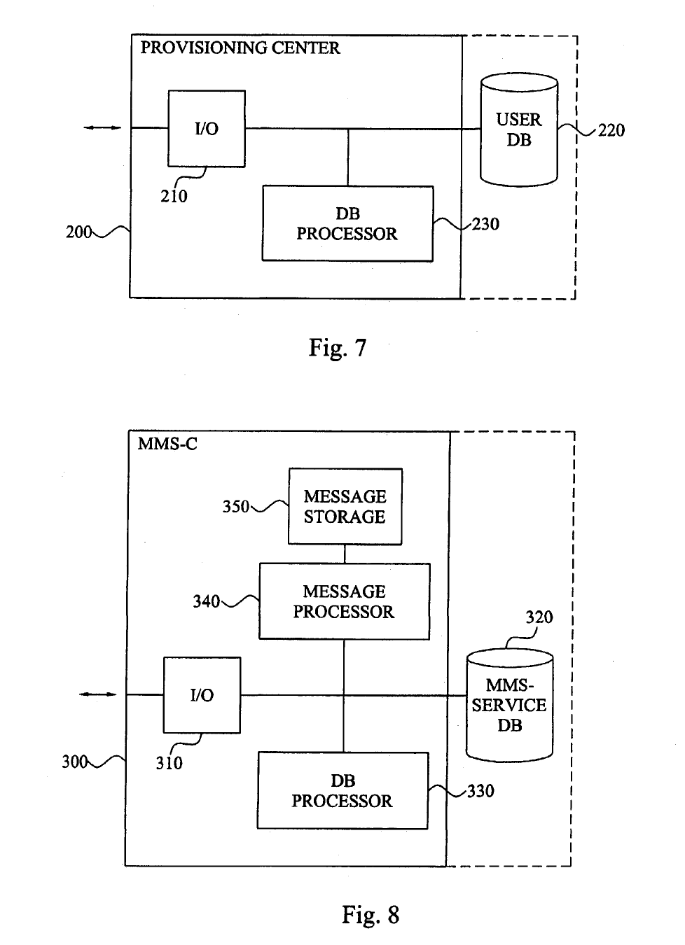

FIG. 7 is a schematic block diagram of a provisioning center 200 according to an embodiment of the invention. The center 200 comprises an input/output (I/O) unit 210 conducting communication between the provisioning center 200 and other units of the mobile communication system. The I/O unit 210 is in particular provided for receiving the detection message from the ADC and for forwarding the detection message supplemented with additional information of payment method and other service-agreement-related information to the MMS-C.

A user database, table or register 220 is also arranged in, or associated with, the provisioning center 200. This user database 220 comprises information of payment method and additional service-agreement related information associated with a service agreement of a user. In a typical embodiment, the database 220 includes entries comprising the MSISDN, IMSI or mobile telephone number of the user, payment information regarding MMS services, the subscription of the user and/or other chargeable services. Furthermore, the entry states allowances and information of other services connected to the user's subscription or service agreement with the network operator or service provider, respectively.

A database processor 230 is implemented in the provisioning center 200 for retrieving service-agreement-related and payment method information of a user from the database 200 based on service agreement identifier received in the detection message from the ADC.

The units 210 and 230 of the provisioning center 200 may be provided as software, hardware or a combination thereof. They may be implemented together for example in a network node of a mobile communication system. Alternatively, a distributed implementation is also possible with some of the units provided in different network nodes.

An embodiment of an MMS-C 300 is schematically illustrated in the block diagram of FIG. 8. The MMS-C 300 includes an input/output (I/O) unit 310 conducting communication between the MMS-C 300 and other units of the mobile communication system. The I/O unit 310 is in particular provided for receiving the detection message from the ADC or the provisioning center and the MMS request message originating from a mobile unit. In addition, the I/O unit 310 manages transmission of the notification message and also provides MMS messages requested by a mobile unit.

A message processor 340 of the MMS-C 300 generates or provides a notification message including a link to different MMS, which is provided to the I/O unit 310 for transmission to the mobile unit. The message processor 340 preferably provides the linked MMS and/or notification messages from standard messages, based on model identifier of the mobile unit. The standard MMS and notification messages, respectively, are adapted for one or several mobile unit models. These standard messages are stored in a memory 350 in, or associated with, the MMS-C 300.

The message processor 340 also generates an acknowledge message or signal in response to reception of a MMS request originating from a MMS capable mobile unit that has been configured for support of MMS messaging. The acknowledge message includes the service agreement information of the requesting mobile unit and a notice that the unit has been successfully MMS configured.

The MMS-C 300 further comprising, or having access to, a MMS-service database or register 320 that includes MMS delivery method information of the users in the mobile communication system. In a typical embodiment, an entry of the database 320 includes the service agreement identifier of a user, MMS delivery method, i.e. MMS capable or legacy, and preferably also identifier of the model of the user's present mobile unit. Optionally, payment method information, referring to MMS messaging, a subscription and/or other chargeable services, and additional service-agreement-related information is included in the database entry. The communication system then looks up the database entry associated with a user, for example when a MMS is transmitted to or from the user, when additional services are utilized by the user, in order to be able to provide the correct service to the user and charge the service correctly.

A database processor 330 is implemented for updating the MMS-service database 320 in response to reception of the detection message from the ADC or provisioning center, in response to a MMS request from the user or in response to a network operator performing a bulk provision, discussed above. The processor 330 also updates the database 320 based on payment method and additional service-agreement-related information from the provisioning center.

The units 310, 330 and 340 of MMS-C 300 may be provided as software, hardware or a combination thereof. They may be implemented together for example in a network node of a mobile communication system. Alternatively, a distributed implementation is also possible with some of the units provided in different network nodes.

FIG. 9 illustrates a block diagram of an embodiment of a mobile unit 400 applicable in a mobile communication system according to the invention. The mobile unit 400 includes an input/output (I/O) unit 410 conducting communication between the mobile unit 400 and other units of the mobile communication system. The I/O unit 410 is in particular provided for receiving a configuration message and an optional notification message and transmitting a MMS request message.

A (network) subscriber identity module 420 is provided for cooperation with the mobile unit 400. This identity module 420 typically is a SIM card used in GSM, USIM, WIM or ISIM, or another card provided or issued by a network operator to which the user has a subscription or another service agreement. The identity module 420 is associated with a service agreement identifier or subscription identifier, e.g. MSISDN, ISIM or mobile telephone number, allowing identification of the user's service agreement.

Furthermore, information identifying the mobile unit terminal is provided in the mobile unit 400, typically as a hardware or terminal identifier or number 430, e.g. IMEI. In addition to identifying the present mobile unit 400, the identifier 430 preferably also identifies the model of the mobile unit 400.

The mobile unit 400 also comprises means 440, e.g. hardware and/or software, such as program code, enabling the mobile unit 400 to support MMS messaging. This means 440 is often pre-installed in the mobile unit 400 at purchase, but typically requires additional information for correction information, e.g. the address information discussed above. If provided as software, the means 440 could also be downloaded into the mobile unit 400 from a network operator or MMS-service provider and installed in the mobile unit 400, including being installed on the identity module 420.

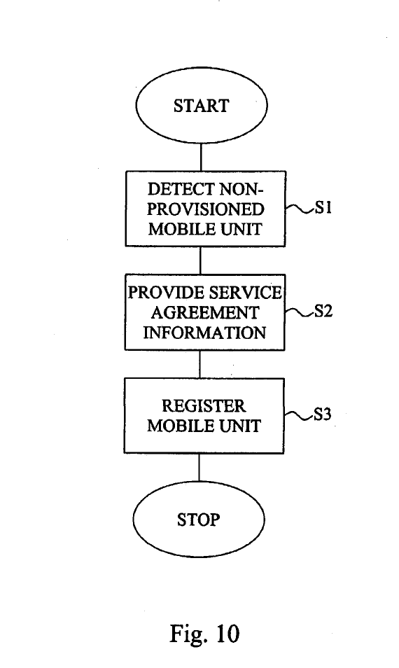

FIG. 10 is a flow diagram of the general steps of an enhanced-service enabling or provisioning method according to the invention. Starting with step S1, a non-provisioned enhanced-service capable mobile unit is detected. Once detected, a detection signal or message including service agreement identifier associated with the mobile unit is generated and provided to an enhanced-service center in step S2. In step S3, the enhanced-service center registers the mobile unit as enhanced-service capable by updating an associated enhanced-service database based on the received service agreement identifier.

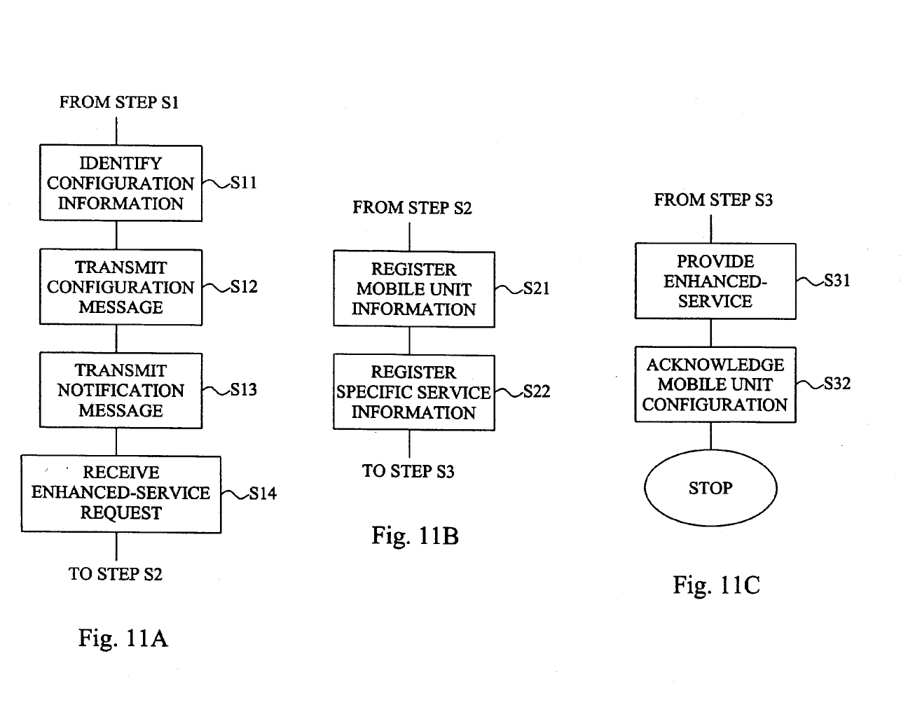

FIGS. 11A-11C illustrates additional steps of the enhanced-service enabling method of the present invention. Starting with step S11 in FIG. 11A, configuration information enabling configuration of a mobile unit to support usage of the enhanced service is identified and provided, preferably based on model identifier of the mobile unit. A configuration message comprising the configuration information is transmitted to the mobile unit, e.g. as an OTA (SMS) message, in step S12. In step S13, a notification message, preferably comprising a link to or means for using an example of the enhanced service, is transmitted to the mobile unit. Upon reception of the notification message and on the assumption that the mobile unit has been configured for supporting the enhanced service, the mobile unit may request the enhanced service provided in the notification message. Thus, an enhanced-service request message is received by the enhanced-service center in step S14.

In FIG. 11B step S21, identifier of the mobile unit, i.e. the model of the mobile unit, e.g. IMEI and/or TAC, is provided to and registered in the enhanced-service center. Based on the service agreement identifier additional specific information of payment method, e.g. of usage of the enhanced service, and/or on other service-agreement-related information is registered in the enhanced-service center in step S22.

In FIG. 11C, the requested enhanced service is provided to the mobile unit in step S31. In step S32, the mobile unit is acknowledged as configured for the enhanced service and a configuration database is updated accordingly.

It will be understood a person skilled in the art that various modifications and changes may be made to the present invention without departure from the scope thereof, which is defined by the appended claims.

What is claimed:

1. A method of enabling an enhanced-service for user equipment in a mobile communication system, said method comprising the steps of:
a user equipment configuration center detecting a non-provisioned enhanced-service capable user equipment; and
in response to said detection, updating an enhanced-service center based on service agreement information associated with said user equipment, thereby provisioning said user equipment as enhanced-service capable for enabling said enhanced service.

2. The method according to claim 1, wherein said service agreement information comprises a subscription identifier associated with a subscriber identity module adapted for cooperation with said user equipment, and said user equipment is associated with user equipment information, said detecting step comprises the step of detecting a new combination of said user equipment information and said subscription identifier.

3. The method according to claim 2, wherein said method comprises the step of further updating said enhanced-service center based on said user equipment information, thereby enabling user equipment specific provisioning of said user equipment.

4. The method according to claim 1, wherein said method further comprises the steps of:
in response to said detection, a service provisioning center retrieving information of at least one service-agreement-related service from an associated service database;
said service provisioning center forwarding said information of at least one service-agreement-related service to said enhanced-service center; and
further updating said enhanced-service center based on said information of at least one service-agreement-related service.

5. The method according to claim 1, wherein said method comprises the further step of said enhanced-service center, in response to said detection, transmitting a notification message to said user equipment, said notification message comprising means for enabling transmission of an enhanced-service request message destined to said enhanced-service center.

6. The method according to claim 1, wherein said method further comprises the steps of:
said enhanced-service center transmitting an acknowledge message to said user equipment configuration center in response to reception of a confirmation that said user equipment has been configured for enabling said enhanced service;
said user equipment configuration center updating a user equipment configuration database in response to said acknowledge message, said user equipment configuration database comprising information of user equipment being configured for said enhanced service.

7. The method according to claim 6, wherein said method comprises the further step of said enhanced-service center, in response to said detection, transmitting a notification message to said user equipment, said notification message comprising means for enabling transmission of an enhanced-service request message destined to said enhanced-service center, wherein said enhanced-service center transmitting said acknowledge message in response to reception of said enhanced-service request message originating from said user equipment.

8. The method according to claim 6, wherein said method further comprises the steps of:
said user equipment configuration center transmitting an enhanced-service configuration message to said user equipment, said configuration message comprising information for enabling configuration of said user equipment to enable usage of said enhanced service; and
said user equipment configuration center retransmitting said configuration message to said user equipment if said acknowledge message has not been received within a predetermined time period.

9. The method according to claim 1, wherein said enhanced service comprises at least one of:
multimedia service;
MMS (Multimedia Messaging Service) service;
IM (Instant Messaging) service;
IMPS (Instant Messaging and Presence Service) service;
multimedia conferencing service;
chat service;
presence service;
location-based service;
streaming service;
digital content download service;
SIP (Session Initiation Protocol) service;
push service;
push-to-talk service;
video telephony service;
video conferencing service; and
enhanced voice service.

10. A provisioning system adapted for enabling an enhanced-service for user equipment in a mobile communication system, said provisioning system comprising:
a user equipment configuration center having means for generating a detection signal in response to detection of a non-provisioned enhanced-service capable user equipment,
an enhanced-service center having means, responsive to said detection signal, for updating an associated enhanced-service database based on service agreement information associated with said user equipment, thereby provisioning said user equipment as enhanced-service capable for enabling said enhanced service.

11. The system according to claim 10, wherein said service agreement information comprises a subscription identifier associated with a subscriber identity module adapted for cooperation with said user equipment, and said user equipment is associated with user equipment information, said signal generating means is configured for generating said detection signal in response to detection of a new combination of said user equipment information and said subscription identifier.

12. The system according to claim 11, wherein said updating means is configured for further updating said enhanced-service database based on said user equipment information, thereby enabling user equipment specific provision of said user equipment.

13. The system according to claim 10, wherein said provisioning system comprises a subscription service provisioning center comprising:
means for retrieving, in response to said detection signal, information of at least one service-agreement-related service from an associated service database; and
means for forwarding said information of at least one service-agreement-related service to said enhanced-service center,
wherein said updating means is configured for further updating said enhanced-service database based on said information of at least one service-agreement-related service.

14. The system according to claim 10, wherein said enhanced-service center comprises means, responsive to said detection signal, for transmitting a notification message to said user equipment, said notification message comprising means for enabling transmission of an enhanced-service request message destined to said enhanced-service center.

15. The system according to claim 10, wherein said enhanced-service center comprises means for transmitting an acknowledge message to said user equipment center in response to reception of a confirmation that said user equipment has been configured for enabling said enhanced service and said user equipment center comprises means for updating a user equipment configuration database in response to said acknowledge message, said user equipment configuration database comprising information of user equipment being configured for said enhanced service.

16. The system according to claim 15, wherein said enhanced-service center comprises means, responsive to said detection signal, for transmitting a notification message to said user equipment, said notification message comprising means for enabling transmission of an enhanced-service request message destined to said enhanced-service center, wherein said acknowledge transmitting means is configured for transmitting said acknowledge message in response to reception of said enhanced-service request message originating from said user equipment.

17. The system according to claim 15, wherein said user equipment configuration center further comprises means for transmitting an enhanced-service configuration message to said user equipment, said configuration message comprising information for enabling configuration of said user equipment to enable said enhanced service, said transmitting means being configured for retransmitting said configuration message to said user equipment if said acknowledge message has not been received within a predetermined time period.

18. The system according to claim 10, wherein said enhanced service comprises at least one of:
multimedia service;
MMS (Multimedia Messaging Service) service;
IM (Instant Messaging) service;
IMPS (Instant Messaging and Presence Service) service;
multimedia conferencing service;
chat service;
presence service;
location-based service;
streaming service;
digital content download service;
SIP (Session Initiation Protocol) service;
push service;
push-to-talk service;
video telephony service;
video conferencing service; and
enhanced voice service.

19. A mobile communication system comprising:
a user equipment configuration center having means for generating a detection signal in response to detection of a non-provisioned enhanced-service capable user equipment;
an enhanced-service center having means, responsive to said detection signal, for updating an associated enhanced-service database based on service agreement information associated with said user equipment, thereby provisioning said user equipment as enhanced-service capable for enabling said enhanced service.

20. The mobile communication system according to claim 19, wherein said service agreement information comprises a subscription identifier associated with a subscriber identity module adapted for cooperation with said user equipment, and said user equipment is associated with user equipment information, said signal generating means is configured for generating said detection signal in response to detection of a new combination of said user equipment information and said subscription identifier.

21. The mobile communication system according to claim 20, wherein said updating means is configured for further updating said enhanced-service database based on said user equipment information, thereby enabling user equipment specific provision of said user equipment.

22. The mobile communication system according to claim 19, wherein said system comprises a subscription service provisioning center in turn comprising:
means for retrieving, in response to said detection signal, information of at least one service-agreement-related service from an associated service database; and
means for forwarding said information of at least one service-agreement-related service to said enhanced-service center,
wherein said updating means is configured for further updating said enhanced-service database based on said information of at least one service-agreement-related service.

23. The mobile communication system according to claim 19, wherein said enhanced-service center comprises means for transmitting an acknowledge message to said user equipment center in response to reception of a confirmation that said user equipment has been configured for enabling said enhanced service and said user equipment center comprises means for updating a user equipment configuration database in response to said acknowledge message, said user equipment configuration database comprising information of user equipment being configured for said enhanced service.

24. The mobile communication system according to claim 19, wherein said user equipment center is an automatic device configuration (ADC) unit, said enhanced-service center is a multimedia messaging service center (MMS-C) adapted for provisioning a non-provisioned multimedia-messaging-service capable mobile station.
